(19) United States
(12) Patent Application Publication
(10) Pub. No.: US 2010/0140346 A1
(43) Pub. Date: Jun. 10, 2010

(54) METHODS AND SYSTEMS FOR CAPTURING VALUE FROM A PAYMENT DECLINE OR ERROR

(76) Inventors: Michael Loeb, New York, NY (US); Jon Jensen, New Canaan, CT (US); Edward McCabe, Brooklyn, NY (US)

Correspondence Address: EDWARDS ANGELL PALMER & DODGE LLP, P.O. BOX 55874, BOSTON, MA, 02205, US

(21) Appl. No.: 12/624,940

(22) Filed: Nov. 24, 2009

Related U.S. Application Data
(60) Provisional application No. 61/117,828, filed on Nov. 25, 2008.

(51) Int. Cl. G06Q 40/00

(52) U.S. Cl. 235/379

(57) ABSTRACT

Methods and systems for capturing value from a payment decline or error include receiving a token over a computer network identifying a merchant and a declined or failed transaction initiated by a consumer, receiving confirmation over the computer network that the consumer has accepted an offer for information about why the transaction failed or was declined, requesting transaction data from a payment gateway utilizing the token identifying the merchant and the transaction, receiving transaction data from the payment gateway for the declined or failed transaction, selecting a response to be delivered to the consumer based on the transaction data, and providing the response to the consumer.

### CROSS-REFERENCE TO RELATED APPLICATIONS

This application claims benefit of priority to U.S. Provisional Patent Application No. 61/117,828, filed Nov. 25, 2008, which is incorporated by reference herein in its entirety.

### BACKGROUND OF THE INVENTION

1. Field of the Invention

The present invention relates generally to financial and data transaction methods and systems and more specifically to methods and systems for deriving value from transactions which end in payment decline or error.

2. Description of the Related Art

Credit cards are the most popular online payment option, accounting for more than 90% of all transactions. While the credit card option provides valuable benefits for both the retailer and consumers, a significant number of transactions fail during the credit approval process due to reasons such as, card distress, atypical card usage or spending above a periodic limit. The failure rate for these transactions may be as high as 10 percent.

While the monitoring of accounts for atypical spending and the enforcement of credit limits protect the issuer and cardholders against fraud while limiting lender risk, the resulting rejections lead to a high rate of purchase abandonment. These gating systems can be over inclusive in rejecting transactions and inevitably reject a large number of consumers with sufficient means to make a purchase from completing desired transactions. After a transaction ending in a decline or other error, a good consumer with considered intent to execute a transaction could verify their account information or enter a new 16-digit credit card number. This would complete the transaction and merchants would not suffer a loss in sales due to credit card declines or other errors. In reality, however, the inconvenience of providing the card information, together with a potential negative bias formed against the retailer communicating the rejection results in significant lost sales as consumers leave sites rather than attempt their purchase a second or third time, perhaps with a different card. By some estimates, out of the 10 percent of rejected transactions, half are not completed. As the company has already invested considerable marketing resources to obtain and convert the consumer, these failed transactions result in increased costs and reduced revenue.

While conventional sales and transaction techniques have generally been considered satisfactory for their intended purpose, there still exists a need to provide greater transparency into the payment decline process, thus enabling consumers to more fully understand the health of their credit and financial accounts. Further, there is still a need to help merchants derive value from transactions with consumers that would otherwise abandon their purchase. The subject invention provides a solution for these problems in a manner that educates consumers while helping merchants derive value from failed transactions that would otherwise be valueless.

### SUMMARY OF THE INVENTION

The subject invention is directed to new and useful systems and methods of capturing value from a payment decline or error. In accordance with an exemplary embodiment, the method includes receiving a token over a computer network identifying a merchant and a declined or failed transaction initiated by a consumer with the merchant and receiving confirmation over the computer network that the consumer has accepted an offer for information about why the transaction failed or was declined. The method further includes requesting transaction data from a payment gateway utilizing the token and receiving transaction data from the payment gateway for the declined or failed transaction. The method also includes providing a response to the consumer based on the transaction data.

It is contemplated that the method can further include the step of analyzing the transaction data, wherein the step of providing a response includes selecting a response to be delivered to the consumer based on the transaction data and analysis of the transaction data. A step can be included for creating a record of the consumer in a database. It is also contemplated that the method can further include appending the record of the consumer based on the transaction data. The step of providing the response to the consumer can include communicating the response directly to the consumer, communicating the response to the merchant to communicate to the consumer, or providing the response in any other suitable manner. In certain embodiments, systems and methods in accordance with the invention are configured for providing an informational offer to the consumer to determine the reason for which the transaction has failed.

In certain embodiments, the method includes deriving value from the declined or failed transaction by providing consumer information related to the declined or failed transaction over the computer network as a lead to a third party marketer. The step of deriving value can include providing consumer information to a third party marketer wherein the consumer information includes at least one of an e-mail address, contact information, payment information, and/or any other suitable type of information. The method can include offering to the consumer over the computer network at least one of the following: a new credit account on which the declined or failed transaction can be completed, a one time loan, a new line of credit, a credit report, a credit monitoring product, a finance magazine, a financial newsletter, a discount club membership, and/or any other suitable items or products.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the systems and methods of the subject invention without undue experimentation, preferred embodiments thereof will be described in detail herein below with reference to certain figures, wherein:

FIG. 1 is a schematic view of an exemplary embodiment of a system environment in accordance with the present invention, showing the relationships between the consumer, the merchant, the payment processor, the payment gateway, and the third party service;

FIG. 2 is a table of decline reason codes and corresponding information presented to a consumer in accordance with the invention;

FIG. 3 is a schematic view of an exemplary process in accordance with the invention, showing the steps between confirming a purchase and either processing the transaction, or receipt by a consumer of a decline screen and prompt for more information;

FIG. 4 is a schematic view of the process of FIG. 4, showing the steps subsequent to receipt by a consumer of a decline screen prompting the consumer with an option for more information; and

FIG. 5 is a view of an exemplary payment page showing a decline window including a prompt with an option for more information as displayed to a consumer after a failed transaction in accordance with the invention.

These and other objects of the systems and methods of the subject invention will become more readily apparent to those skilled in the art from the following detailed description of the preferred embodiments.

### DETAILED DESCRIPTION OF THE PREFERRED EMBODIMENTS

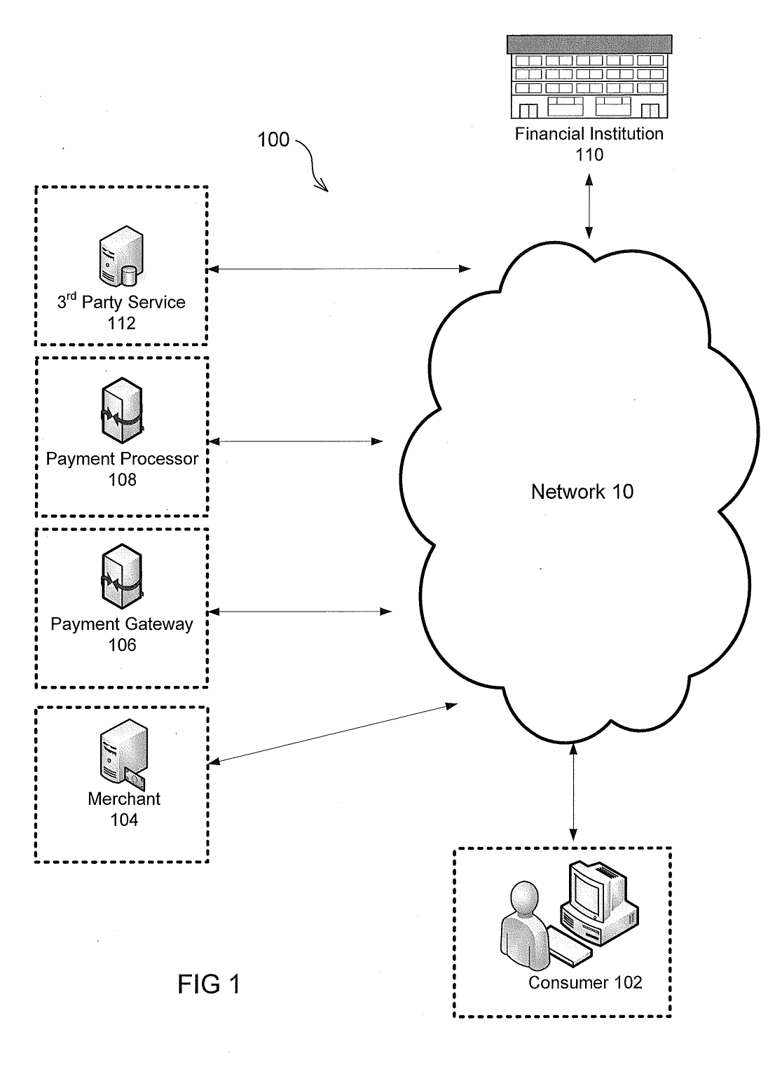

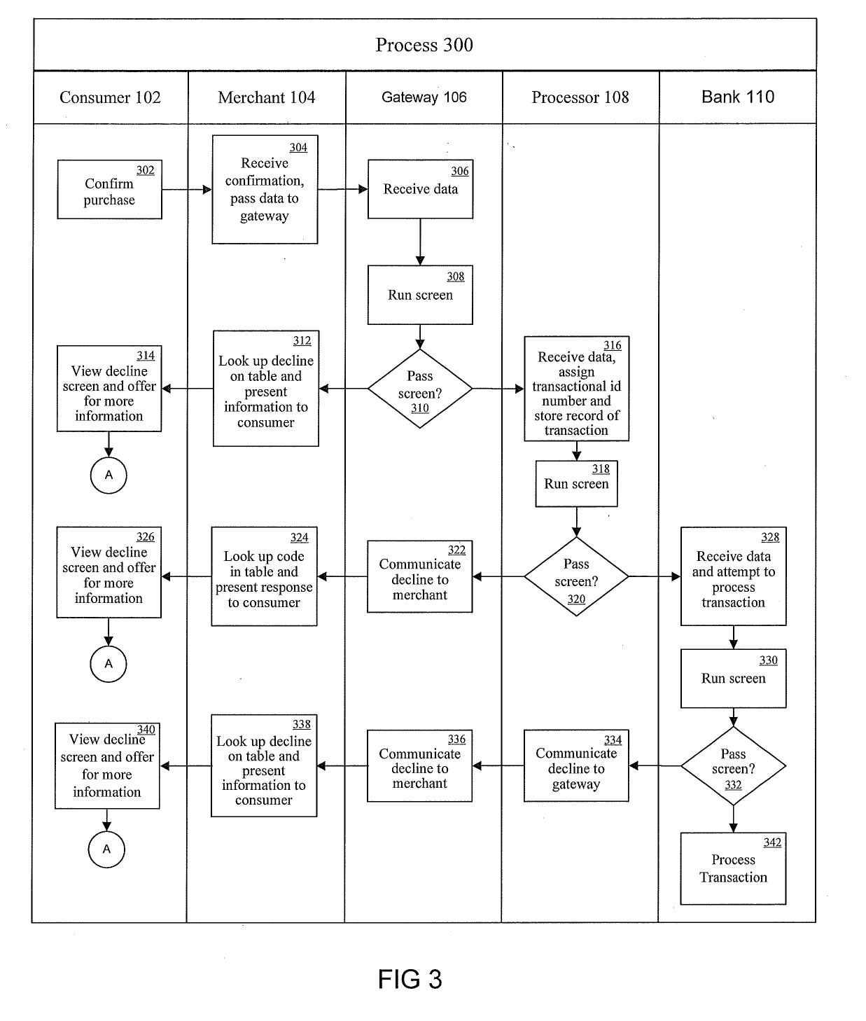

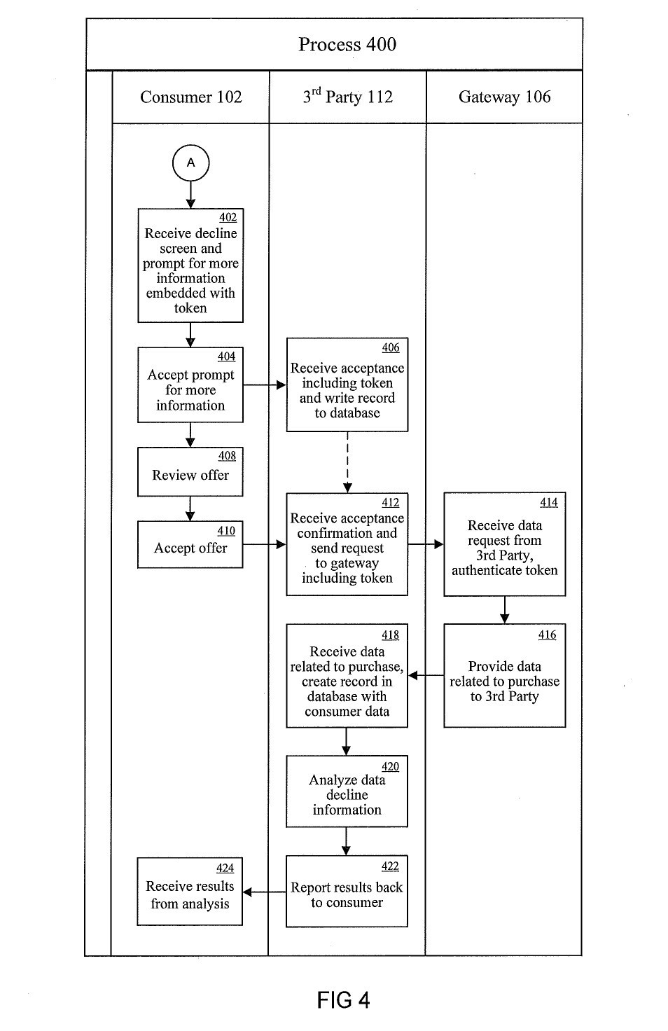

Reference will now be made to the drawings wherein like reference numerals identify similar structural features or aspects of the subject invention. For purposes of explanation and illustration, and not limitation, a schematic view of an exemplary embodiment of the method in accordance with the invention is shown in FIGS. 3 and 4 and is designated generally by reference characters 300 and 400. Other aspects of the method in accordance with the invention are provided in FIGS. 1-2 and 5, as will be described. The systems and methods of the invention can be used to help merchants derive value from transactions with consumers who would otherwise abandon their purchase.

The methods and systems provided herein extend to consumers an informational offer to determine the reason for which their payment has failed. As is well known, internet purchase transactions occur many times each day and a percentage of them are not executed for various reasons, among them being credit decline, processing errors and abandonment. Each error or rejection is associated with a decline reason code delivered from the financial institution, payment processor or payment gateway to the merchant. The merchant, in most cases, receives the reason code from their gateway and communicates a generic message to the consumer indicating that payment has been declined without any additional information. As will become apparent, these and other drawbacks are addressed by the present invention by offering the consumer an option to ascertain the reason for which their payment has failed.

FIG. 1 illustrates an exemplary system environment in which the features and principles of the invention may be implemented. As illustrated in FIG. 1, the system environment includes a customer or consumer 102, merchant 104, payment gateway 106, payment processor 108, financial institution 110, and third party service 112. Each of these entities interacts with one another through network 10.

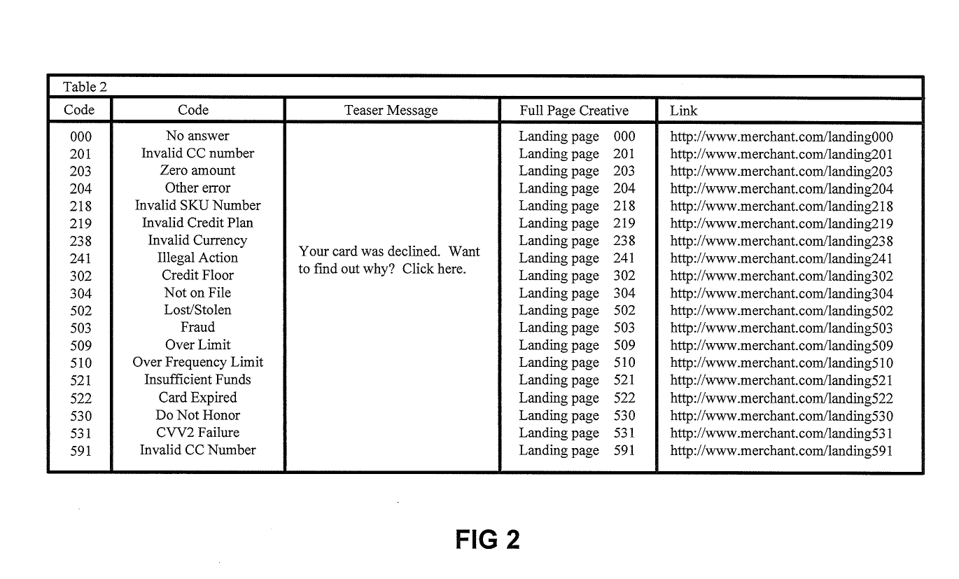

In a pre-operational stage, merchant 104, third party service 112, and payment gateway 106, acting as a partner of merchant 104, amend a table, such as the exemplary table represented by FIG. 2, which associates a decline reason code received through gateway 106 and information to be presented to consumer 102. Gateways originally provide tables to merchants. Thus, generally merchants will already have a table. A pre-existing table is amended in the pre-operational stage to include additional information to be presented to consumer 102. In the case of a new merchant, a new table is provided having the same information. The information presented to consumer 102 may include text, images, and/or a link to an associated URL maintained by third party 112 service. This information defines the message and content to be displayed to consumer 102 at the point of a payment failure. This information can be amended later as needed. Also, the system can be configured so that changing the linked offer, appearance, etc., can be made without affecting the table.

With reference now to FIG. 3, there is shown a process 300 for providing an informational offer to a consumer in response to a consumer's payment being declined during a point-of-sale transaction. The process 300 is described in connection with consumer 102 participating in a point-of-sale transaction with merchant 104, as shown and described above with reference to FIG. 1. Those skilled in the art will readily understand that what follows is meant to be representative of a typical transaction, by way of example and not limitation.

At step 302, consumer 102 confirms a purchase through merchant 104 where such confirmation includes passing on personal information such as name, address, phone number and payment account information together with an affirmative consent to make a purchase. At step 304, merchant 104 receives the purchase request from consumer 102 and forwards data provided by consumer 102 to payment gateway 106. At step 306, payment gateway 106 receives the data from merchant 104. At step 308, payment gateway 106 performs a preliminary analysis of the consumer's payment information using, for example, a standard Mod 10 algorithm to control for keystroke errors. Such techniques are well known in the retail art.

At step 310, a determination step, assuming the payment account information passes the test for keystroke errors in accordance with the Mod 10 algorithm and any other applicable screen, payment gateway 106 then forwards the consumer credit request to payment processor 106. In the case that the payment account information does not pass the screens applied in step 310, payment gateway 106 passes a response back to merchant 104 including a reason code associated with the reason for which the payment was declined.

At step 312, merchant 104 receives notification of the payment decline from payment gateway 106, looks up the decline code on a table (e.g. FIG. 2) and presents related information to consumer 102. At step 314, consumer 102 receives notification of the payment decline from merchant 104 and is presented an offer to receive more information about the reason for the decline.

If the payment account information passes the screens applied at step 310, then at step 316, payment processor 108 receives data from payment gateway 106. At step 318, payment processor 108 performs an analysis of the consumer's payment information as a screen. At step 320, a determination step, assuming the payment account information passes the internal screen, payment processor 108 then forwards the payment information to financial institution 110 (referred to as “Bank 110” in FIG. 3). In the case that the payment information does not pass the screens applied in step 318, the payment processor 108 passes a response back to the payment gateway 106 including the reason for which the payment was declined.

At step 322 payment gateway 106 receives the decline notification from payment processor 108 and communicates the decline to merchant 104. At step 324, merchant 104 receives notification of the payment decline from payment gateway 106, looks up the decline code on a table and presents related information to consumer 102. Step 324 is performed automatically, for example by a server or other computer system handling the internet transaction with consumer 102. At step 326, consumer 102 receives notification of the payment decline from merchant 104 and is presented an offer to receive more information about the reason for the decline. While merchant 104, payment gateway 106, payment processor 108, and third party service 112 are referred to as separate entities, it is to be understood that any or all of these entities can be combined in a single entity without departing from the spirit and scope of the invention.

At step 328 which follows from determination step 320, financial institution 110 receives payment data from payment processor 108. At step 330, financial institution 110 attempts to process the payment according to their proprietary standards. At step 332, a determination step, assuming the payment information is acceptable, the financial institution accepts the charge to the account controlled by consumer 102. At step 342 which follows from determination step 332, financial institution 110 processes the charge to an account of consumer 102, meaning the transaction was successful. In the case that the payment information is found to be unacceptable, financial institution 110 responds to payment processor 108 with a decline reason code specific to the reason for which the payment was declined. Those skilled in the art will appreciate that codes are generally standard between processors, gateways, banks, etc. It is the job of a gateway to understand all codes it receives and to be able to translate them into a language or code that a given merchant can understand based upon their respective table.

At step 334 payment processor 108 receives the decline notification from financial institution 110 and communicates the decline to payment gateway 106. At step 336 payment gateway 106 receives the decline notification from payment processor 108 and communicates the decline to merchant 104. At step 338, merchant 104 receives notification of the payment decline from payment gateway 106, looks up the decline code on a table and presents related information to the consumer. The response provided to consumer 102 at this point is a generic response. At step 340, consumer 102 receives notification of the payment decline from merchant 104 and is presented an offer to receive more information about the reason for the decline.

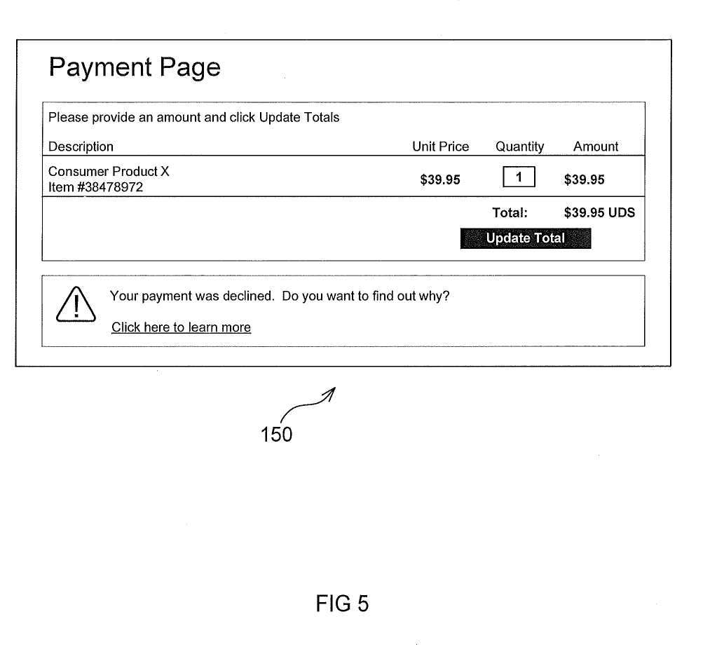

In short, a transaction going through process 300 in FIG. 3 ends either in success at step 342, or else in an error or decline screen prompting consumer 102 with an option to find out more information, which is indicated by reference character A after steps 314, 326, and 340. Such an offer can be presented to consumer 102, for example, in the form of a window displayed on the screen of the consumer's computer, for example. FIG. 5 shows an exemplary page or window 150 indicating that a consumer's payment was declined, and providing a link to more information.

With reference now to FIG. 4, there is shown a process 400 which continues from any point A in process 300 in which a consumer is presented an offer for more information about their payment decline. At step 402, consumer 102 receives notification of the decline and is presented a simple offer, in the form of the link mentioned above, to find out the reason for which their payment was declined. It should be understood that embedded within the code associated with this link and offer is a token, e.g., alpha-numeric code, which identifies both the transaction number and merchant. At step 404 consumer 102 accepts the offer for more information, for example, by clicking a corresponding link, and is transferred to a new landing page associated with the offer.

At step 406, third party service 112 receives notification of the acceptance including the token and writes a record of the acceptance and token to a database. At step 408, consumer 102 reviews the offer presented on the landing page. At step 410 consumer 102 accepts the offer for more information.

At step 410, acceptance by consumer 102 of the offer for more information is received by a third party service 112. At step 412, third party service 112, having received the acceptance by consumer 102, sends a request to gateway 106 for all relevant transactional data associated with the token. At step 414, gateway 106 receives the request from third party service 112. At step 416, gateway 106 validates the request by third party service 112 and responds with requested data. While gateway 106 is described as receiving the request and providing this data, those skilled in the art will readily appreciate that it is also possible for these functions to be performed by a merchant, processor, or any other suitable entity.

At step 418, third party service 112 receives all relevant information related to the transaction and creates a record in a database containing the consumer information or amends an existing record with the consumer information. At step 420, third party service 112 analyzes the decline information provided by payment gateway 106 and at step 422, provides a report back to the consumer. Such communication could take the form of an e-mail, text message, or other electronic communication, or otherwise could be a letter mailed to consumer 102, or any other suitable communication. At step 424, consumer 102 receives the report of the reason for which the payment was declined, including results from the analysis, if applicable.

The invention provides significant benefits and advantages to both merchants and customers. By providing consumers an integrated means of ascertaining why their payment has failed, the invention enables merchants to provide valuable insight for consumers into the reason behind their purchase failure, increasing the chances that the consumer will complete the purchase. Further, it provides an opportunity for the merchant to sell consumer information as a lead to a 3^{rd} party marketer, thus deriving some economic value from a base of consumers that would otherwise be valueless. This economic value can be derived, for example, by offering the consumer a new credit account on which they can complete their purchase, a one time loan, a new line of credit, credit reports, a credit monitoring product, finance magazines or newsletters, discount club, or other products. The third party service entity can gain an e-mail address, contact information, and/or payment information related to the consumer. This can also include the ability to remarket to consumers in the future.

While systems and methods of the subject invention have been shown and described with reference to preferred embodiments, those skilled in the art will readily appreciate that changes and/or modifications may be made thereto without departing from the spirit and scope of the subject invention.

What is claimed is:

1. A method of capturing value from a payment decline or error, the method comprising the steps of:
a) receiving a token over a computer network identifying a merchant and a declined or failed transaction initiated by a consumer with the merchant;
b) receiving confirmation over the computer network that the consumer has accepted an offer for information about why the transaction failed or was declined;
c) requesting transaction data from a payment gateway utilizing the token;
d) receiving transaction data from the payment gateway for the declined or failed transaction; and
e) providing a response to the consumer based on the transaction data.

2. A method as recited in claim 1, further comprising the step of analyzing the transaction data, wherein the step of providing a response includes selecting a response to be delivered to the consumer based on the transaction data and analysis of the transaction data.

3. A method as recited in claim 1, further comprising the step of creating a record of the consumer in a database.

4. A method as recited in claim 3, further comprising the step of appending the record of the consumer based on the transaction data.

5. A method as recited in claim 1, wherein the step of providing a response to the consumer includes communicating the response directly to the consumer.

6. A method as recited in claim 1, wherein the step of providing a response to the consumer includes communicating the response to the merchant to communicate to the consumer.

7. A method as recited in claim 1, wherein the step of providing a response to the consumer includes offering to the consumer over the computer network at least one item selected from the group consisting of a new credit account on which the declined or failed transaction can be completed, a one time loan, a new line of credit, a credit report, a credit monitoring product, a finance magazine, a financial newsletter, and a discount club membership.

8. A method of capturing value from a payment decline or error, the method comprising the steps of:
a) receiving a token over a computer network identifying a merchant and a declined or failed transaction initiated by a consumer with the merchant;
b) receiving confirmation over the computer network that the consumer has accepted an offer for information about why the transaction failed or was declined;
c) requesting transaction data from a payment gateway utilizing the token;
d) receiving transaction data from the payment gateway for the declined or failed transaction;
e) providing a response to the consumer based on the transaction data; and
f) providing consumer information related to the declined or failed transaction as a lead to a third party marketer.

9. A method as recited in claim 8, further comprising the step of analyzing the transaction data, wherein the step of providing a response includes selecting a response to be delivered to the consumer based on the transaction data and analysis of the transaction data.

10. A method as recited in claim 8, further comprising the step of creating a record of the consumer in a database.

11. A method as recited in claim 10, further comprising the step of appending the record of the consumer based on the transaction data.

12. A method as recited in claim 8, wherein the step of providing a response to the consumer includes communicating the response directly to the consumer.

13. A method as recited in claim 8, wherein the step of providing a response to the consumer includes communicating the response to the merchant to communicate to the consumer.

14. A method as recited in claim 8, wherein the step of providing consumer information includes providing to the third party marketer at least one item selected from the group consisting of an e-mail address, contact information, and payment information.

15. A method as recited in claim 8, further comprising offering to the consumer over the computer network at least one item selected from the group consisting of a new credit account on which the declined or failed transaction can be completed, a one time loan, a new line of credit, a credit report, a credit monitoring product, a finance magazine, a financial newsletter, and a discount club membership.

16. A method of capturing value from a payment decline or error, the method comprising the steps of:
a) receiving a token over a computer network identifying a merchant and a declined or failed transaction initiated by a consumer with the merchant;
b) receiving confirmation over the computer network that the consumer has accepted an offer for information about why the transaction failed or was declined;
c) requesting transaction data from a payment gateway utilizing the token;
d) receiving transaction data from the payment gateway for the declined or failed transaction;
e) providing a response to the consumer based on the transaction data; and
f) deriving value from the declined or failed transaction by providing consumer information related to the declined or failed transaction over the computer network as a lead to a third party marketer.

17. A method as recited in claim 16, further comprising the step of analyzing the transaction data, wherein the step of providing a response includes selecting a response to be delivered to the consumer based on the transaction data and analysis of the transaction data.

18. A method as recited in claim 16, wherein the step of providing a response to the consumer includes communicating the response to the merchant to communicate to the consumer.

19. A method as recited in claim 16, wherein the step of deriving value includes providing consumer information to a third party marketer wherein the consumer information includes at least one item selected from the group consisting of an e-mail address, contact information, and payment information.

20. A method as recited in claim 16, further comprising offering to the consumer over the computer network at least one item selected from the group consisting of a new credit account on which the declined or failed transaction can be completed, a one time loan, a new line of credit, a credit report, a credit monitoring product, a finance magazine, a financial newsletter, and a discount club membership.
